(19) United States
(12) Patent Application Publication
(10) Pub. No.: US 2010/0296703 A1
(43) Pub. Date: Nov. 25, 2010

(54) METHOD AND DEVICE FOR DETECTING AND CLASSIFYING MOVING TARGETS

(75) Inventor: Jed Marti, Salt Lake City, UT (US)

Correspondence Address: NIXON & VANDERHYE, PC, 901 NORTH GLEBE ROAD, 11TH FLOOR, ARLINGTON, VA, 22203, US

(73) Assignee: ARTIS LLC, Herndon, VA (US)

(21) Appl. No.: 12/783,585

(22) Filed: May 20, 2010

Related U.S. Application Data
(60) Provisional application No. 61/180,348, filed on May 21, 2009.

(51) Int. Cl. G06K 9/00

(52) U.S. Cl. 382/103

(57) ABSTRACT

Horizontal velocity profile sensing techniques, methods and systems may be used to detect and classify moving targets, including but not limited to a person, an animal, or a vehicle, or any other object that lends itself to characterization. Such techniques, methods and systems may be implemented with an autonomous stand-alone device, for example, as an unattended ground sensor, or it may constitute part of a sensor system. An exemplary illustrative non-limiting implementation allows the device to be fixed to a location, while detecting and classifying moving targets. In another exemplary illustrative non-limiting implementation, the device may be placed on a moving or rotating platform and used to detect stationary objects.

### CROSS-REFERENCES TO RELATED APPLICATIONS

This application claims the benefit of provisional application No. 61/180,348 filed May 21, 2009, the contents of which are incorporated herein by reference.

### STATEMENT REGARDING FEDERALLY SPONSORED RESEARCH OR DEVELOPMENT

### Field

The technology herein relates to object detection and classification, and to devices that can autonomously detect and classify human and non-human targets. More particularly, the technology herein relates to horizontal velocity profiling and other methods and apparatus that may be used to detect and classify moving targets, including but not limited to a person, an animal, or a vehicle, or any other object that lends itself to characterization.

### BACKGROUND AND SUMMARY

Much work has been done in the past to automatically detect and classify objects. For example, automatically detecting intruders and distinguishing a human intruder from a large animal such as a deer or dog has long been a goal of many security and defense systems. Hunters have long sought systems that can distinguish between an acceptable target such as a deer or a bear and an unacceptable target. Known solutions are able to detect the presence of moving targets but few are able to classify and confirm the moving target autonomously, i.e. without human intervention to confirm that the classification is correct. Some known technologies track warm targets using infrared sensors through limited space, but such solutions typically assume that the warm target is human and not a large animal. Other challenges in conventional human detection technologies are their large power consumption, complex detection algorithms, expense, and dependence on specific sensors.

The technology herein relates to techniques, methods and systems that may be used to detect and classify moving targets, including but not limited to a person, an animal, or a vehicle, or any other object that lends itself to characterization. Such techniques, methods and systems may be implemented with an autonomous stand-alone device, for example, as an unattended ground sensor, or it may constitute part of a sensor system. In either case, an exemplary illustrative non-limiting implementation allows the device to be fixed to a location, while detecting and classifying moving targets. In another exemplary illustrative non-limiting implementation, the device may be placed on a moving or rotating platform and used to detect stationary objects.

In one exemplary illustrative non-limiting implementation providing a method and device wherein the device is located on a stationary platform at a fixed location, the device includes but is not limited to a detector, an optical component, a microcontroller, a memory component, a search engine, a power source, and a method or component to send data to a main processing unit or center for further analysis. An exemplary illustrative device's operation may described as follows. Initially, the detector operates at low sample rate. As the moving target enters the detector's field of view limited by the optical component, the detector senses a change and increases its sample rate to record data useful for classification. Once desired data is recorded, the microcontroller reduces the detector's sample rate. The search engine compares the recorded data with the sample target data stored in the memory component, and either finds a match and identifies it with a known type of target or dismisses it as an unknown target. If the target is classified, the information relating to the type of target can be transmitted to a central processing unit or stored on the device for later processing. A multiplicity of such devices may be distributed in an area to monitor the type and corresponding occurrence of previously specified moving targets. The resulting data may be tailored to or used by any desired application.

Exemplary, non-limiting advantageous features and advantages provided by illustrative exemplary non-limiting implementations include:
Operates with minimal power consumption
Accommodates various portable form factors
Detects moving target or targets autonomously
Compares image of moving target to library of targets located on device
Classifies moving target or targets autonomously
Classification method is fast
Velocity components measured by sensor across human movements are uniform; library of velocity components is relatively small
Records an image of moving target or targets autonomously
Records the type or classification of the target autonomously
Records the time of detection and classification of target autonomously
Records the velocity of the moving target
Records the direction of the moving target
Counts type of moving target autonomously
Records type and corresponding number of moving targets
Capable of keeping a library of one or more target types (such as human, human with backpack, dog, bicycle, horse, etc.)
Simple classification method can be implemented on low-power microprocessors
Simple search engine can be implemented on low-power microprocessors
May be coupled to a device that transmits data back to a central unit or processing center
May transmit the data back to a central unit or processing center
May store the data in additional memory unit
May operate with different types of optical detectors, including but not limited to those which detect energy in the visible range, the near infrared, the mid-infrared, and the long-wave infrared
May be designed to operate during the day and at night depending on which type of detector is used
May operate in a variety of outdoor environments
May operate in a variety of temperature conditions
May operate in a variety of weather conditions
Search engine, detector, memory, component to transmit data controlled by a microcontroller
May be fixed onto a stationary platform, such as a tree, cactus, pole
May be buried underground with an optical imaging fiber bundle transmitting the image to the detector
Infrequent battery changes
Durable
Can be easily serviced by personnel with minimal technical ability
May contain a detachable memory device
Detachable memory device may allow simple interchange of classification data
Interchange of classification data permits easy upgrade of device to accommodate different or more target types
May transmit a message with low battery power warning
May operate as a stand-alone device
May operate as part of sensor network using a multiplicity of these devices
May operate as an additional component of a different type of sensor not described herein
May operate as part of sensor network containing the device type described herein and other types of sensor devices
Classification method may be implemented on the non-limiting exemplary device or device may collect data and classification may be performed on a personal computer or other external computing device
Detector consists of a sensor array that contains at least one row or column of sensors
The maximum range, i.e. the distance from the detector depends of the number of sensor elements in the array
Detector can accommodate one or more maximum ranges
Device can be tailored to accommodate different types of application from long-range to short-range surveillance to traffic monitoring of types of targets in different types of environments
Low false alarm rate
May contain an on-board user interface

### BRIEF DESCRIPTION OF THE DRAWINGS

These and other features and advantages will be better and more completely understood by referring to the following detailed description of exemplary non-limiting implementations in conjunction with the drawings. The file of this patent contains at least one drawing executed in color. Copies of this patent with color drawing(s) will be provided by the Patent and Trademark Office upon request and payment of the necessary fee. The drawings are briefly described as follows:

FIG. 1A shows an exemplary illustrative non-limiting device in the vicinity of a central processing unit;

FIG. 1B shows a device as part of a group of devices transmitting data back to the central processing unit;

FIG. 2 shows an exemplary illustrative non-limiting overview of a device structure comprising of several parts each of which performs certain functions;

FIG. 3 shows an exemplary illustrative non-limiting flowchart outlining an example illustrative non-limiting device algorithm and method for target detection and classification;

FIG. 4 shows an exemplary illustrative non-limiting image from black and white video sampling;

FIG. 5 shows an exemplary illustrative non-limiting line profile of a target sampled at red line as that target moves across the scene;

FIG. 6 shows an exemplary illustrative non-limiting lens system including a convex or converging lens;

FIG. 7 shows exemplary illustrative non-limiting noise caused by sensor motion in wind;

FIG. 8 show exemplary illustrative non-limiting noise from waving leaves and shadows during a breeze while a subject is crawling;

FIG. 9 shows an exemplary illustrative non-limiting foreground shimmer from hot sand and rocks;

FIG. 10 shows an exemplary illustrative non-limiting large fork lift (going backwards) trailing dust;

FIG. 11 shows an exemplary illustrative non-limiting state machine for isolating targets;

FIG. 12 shows an exemplary illustrative non-limiting connected neighbor blocks;

FIG. 12A shows an exemplary illustrative non-limiting processing flowchart;

FIG. 13 shows an exemplary illustrative non-limiting analysis of a moving car and butterfly;

FIG. 14 shows an exemplary illustrative non-limiting analysis of a car isolated from the horizontal velocity profile image;

FIG. 15 shows an exemplary illustrative non-limiting analysis of three people walking in a line with two background people;

FIG. 16 shows an exemplary illustrative non-limiting comparison between two horizontal velocity profile image sets;

FIG. 17 shows an exemplary illustrative non-limiting analysis of two typical horizontal velocity profile images of a walking human

FIG. 18 shows an exemplary illustrative non-limiting analysis of a dog vs. sprinting human;

FIG. 19 shows an exemplary illustrative non-limiting analysis of slow, medium and fast walking;

FIGS. 20A and 20B show an exemplary illustrative non-limiting analysis of walking humans at 10 and 100 meters, respectively;

FIG. 21 shows an exemplary illustrative non-limiting analysis of a slowly walking subject;

FIG. 22 shows an exemplary illustrative non-limiting analysis of a bicyclist going twice as fast;

FIGS. 23A and 23B show an exemplary illustrative non-limiting analysis of identical targets near (30′) and far (130′), respectively

FIGS. 24A and 24B show an exemplary illustrative non-limiting analysis of a subject with and without a backpack, respectively; and

FIGS. 25A and 25B show an exemplary illustrative non-limiting analysis of a subject without and with a backpack, respectively.

### DETAILED DESCRIPTION

### Exemplary Illustrative Non-Limiting Overall System

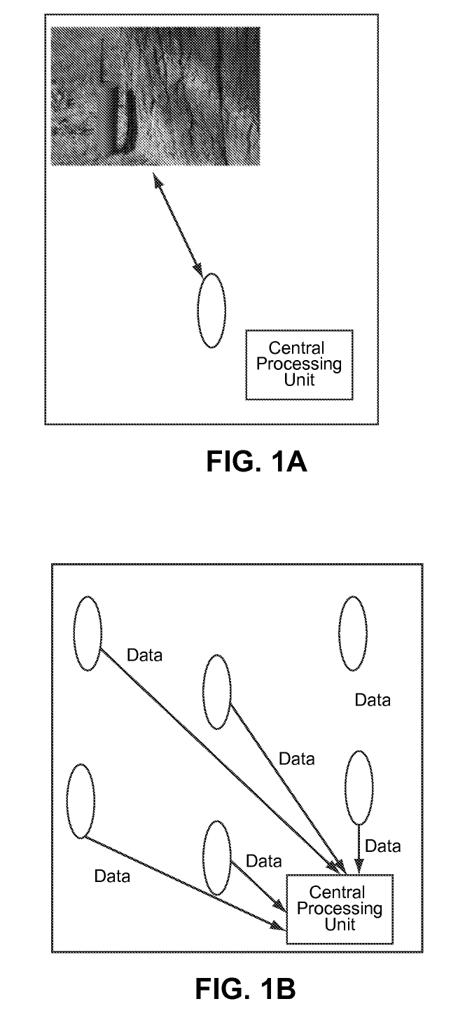

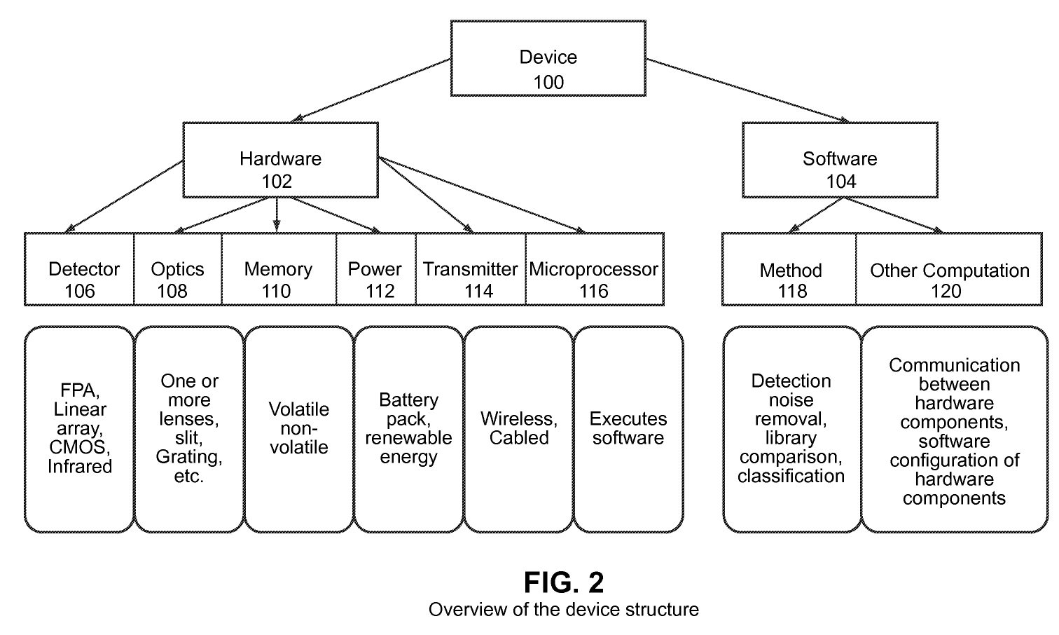

The exemplary illustrative non-limiting device may be used by itself or as part of a group distributed throughout an area. A non-limiting example of the device by itself and as part of a group of similar or dissimilar devices is shown in FIGS. 1 and 2, respectively. The upper left corner of FIG. 1 shows a device in an inconspicuous location next to a tree. These devices can elect to store the data and/or transmit data wirelessly and/or by wire to a main processing unit. The data transmitted may contain information as to the type and corresponding number of each object the device classified and/or it may contain image or images as seen by the detector. Alternatively, the data may take an entirely different form. The data may be transmitted upon classification or the device may be set up to transmit data periodically regardless of whether an event has occurred.

As shown in FIG. 2, each device 100 in the exemplary illustrative non-limiting implementation comprises two main elements: hardware 102 and software 104. Hardware components 102 include but are not limited to a detector 106, an optical component 108, a microprocessor 116, a memory component 110, a power source 112 and circuit board, a transmitter 114 and other components (e.g., a hardware search engine). See FIG. 2.

The detector 106 could be a focal plane array, i.e. a two-dimensional detector array or a linear array. Depending on whether the device should operate at both at night and during the day or on the target type, the detector may be sensitive in the infrared, the visible area, a combination of the two, or a different range of the spectrum.

The optical component 108 may be added to limit the detector's field of view. Optics 108 may for example provide an individual lens or a combination of optical devices, such as a slit or a grating in addition to one or more lenses as known to those familiar with the art. The memory device 110 can be a combination of volatile and non-volatile memory and located on a dedicated memory board or partially integrated with one or several microprocessors 116 to form the search engine. There are several types of memory commercially available that satisfy the requirements of this device, including but not limited to SD cards and flash memory. The memory 110 serves to store the data as well as the library of identifiable targets. An additional benefit of non-volatile memory is that it allows a potential user to remove the data without powering up, operating the device, or communicating with it from a main processing unit.

The power component 112 may consist of batteries or renewable energy forms with a processing circuit to illicit the voltages and currents and provide sufficiently clean signals for proper operation of the device's components. The transmitter 114 enables the device to send its data via a wireless connection or a wired connection. The particular type of transmitter used as part of this device may be specific to the application, and depends on the size, speed, and frequency of data transmissions and are known to those familiar with art.

The microcontroller 116 both holds and executes the software 104. The exemplary illustrative non-limiting implementation includes at least one dedicated microcontroller for the detector 106 and a combination of microcontrollers 116 to support the use of the memory components 110. The software 104 provides the methods of detection and classification 118 and other processes 120, for example, the communications between the various hardware components and determining when certain components are operated at low-power levels.

### Exemplary Illustrative Non-Limiting Method of Detection and Classification: General Operation

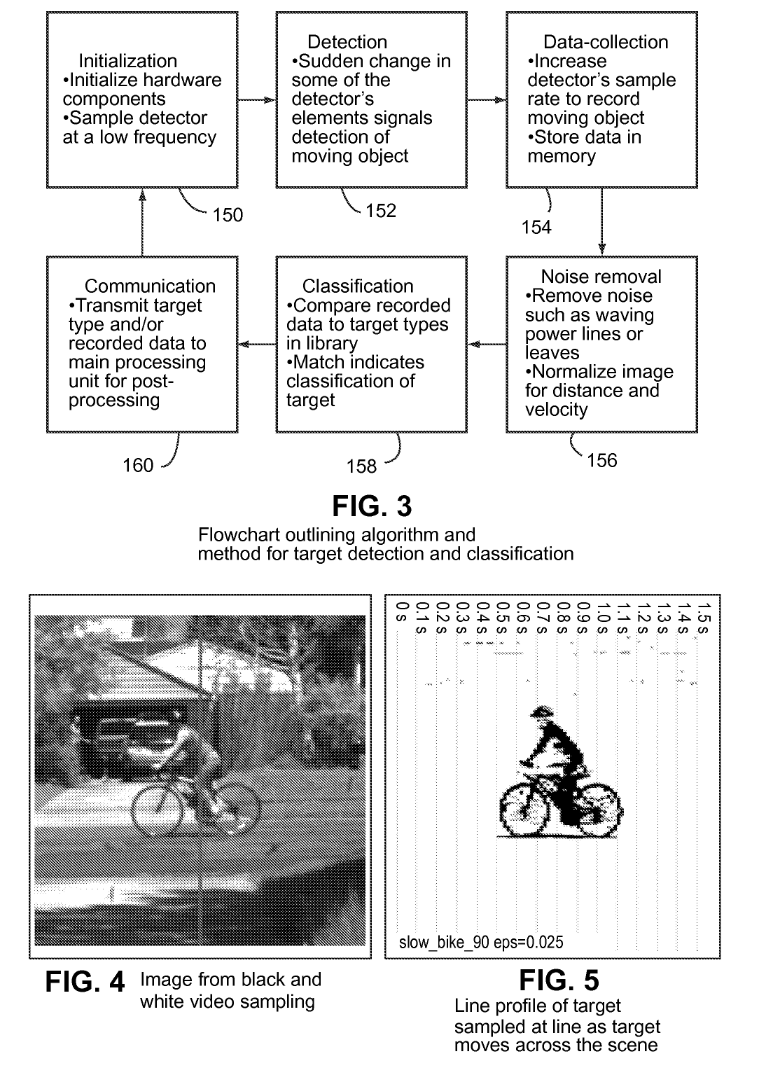

The following section describes an exemplary illustrative non-limiting method for detection and classification of a target. The algorithm, a block diagram of which is shown in FIG. 3, consists of six processing phases, including (1) initialization 150, (2) the detection phase 152, (3) the data-collection phase 154, (4) the noise removal phase 156, (5) the classification phase 158, and (6) the communication phase 160.

During initialization 150, the detector samples the field of view at a low frequency (to reduce power consumption), looking for a change in the background. A non-limiting exemplary change could also occur when one or several detector elements exceed their thresholds. Since the detector is only looking at one vertical line and the device is stationary, a sudden change in some detector elements indicates the appearance of a moving object.

Once a potential target has been detected (block 152), the device switches to the data-collection mode (block 154) by increasing its sample frequency and recording the image until no change in the background is detected (consuming more power). As part of the noise removal phase (block 156), the device removes noise generated by moving leaves and branches, power lines, etc., and normalizes the image for distance and velocity. It then compares the image to a library of identifiable targets and classifies the object upon a match (block 158). Subsequently, the target type and number are stored and transmitted to a central processing unit (block 160), after which the whole process repeats itself (block 150).

A particularly advantageous and salient feature of this method of an exemplary illustrative non-limiting implementation is the recognition that the velocity components measured by the device are uniform across most human movements and that the library of such for a given target is relatively small. Additional advantageous features of an exemplary illustrative non-limiting implementation include reduced power consumption as a consequence of (1) reducing the sample rate of the detector and (2) sampling only one line of the detector or using a linear array as a detector.

FIG. 4 is a non-limiting example of an imaged target as seen by a linear array simulated by post-processing a video image collected at 60 Hz with a CMOS camera. As the target moves across the sensor's field of view, represented by the center vertical line (FIG. 4), the image shown in FIG. 5 is compiled.

The black conglomeration of pixels in FIG. 5 represents the isolated target formed from the “sudden change” with respect to its background experienced by pixels along the vertical line. The black pixels scattered above the target are illustrative non-limiting examples of noise caused by waving leaves and power lines. The shadow is also visible beneath the bicycle. In order for the target classification method to be applied to the device, the detector's sampled linear portion can be nearly perpendicular to the target's motion so that the image represents a spatial and temporal velocity profile of the target. The target classification method can accommodate small deviations in the angle between the detector's sampled linear portion and the target's motion. The linear portion of the sensor should also be positioned orthogonally with respect to the ground surface. For example, in the example implementation, the sensor captures the vertical profile of an upright human target, as the human target moves past the sensor.

### Exemplary Illustrative Non-Limiting Detector Characteristics

In the following sections, some of the hardware components, the device's performance and their effects on the ability of the device to operate in different environments and applications are discussed in more detail.

The detector 106 may consist of one or a combination of infrared or visible imagers. Non-limiting illustrative examples of visible imagers are CMOS and CCD cameras. Non-limiting examples of infrared imagers are pyroelectric arrays and microbolometers. There are many characteristics of the detector that govern its performance, but one that is common to the entire energy spectrum is its resolution. For the autonomous implementation of the method, an exemplary illustrative non-limiting detector 106 may have for example:
Medium resolution. A camera that generates an image 320 pixels tall for a human at 10 meters will create slightly more than 32 pixels of the same human at 100 meters. The resolution of the target's picture may enable a human operator to verify the target's classification at the maximum operating range of the device.
Low power. The sensor should preferably not consume significant power.
Small size. The detector is only one small part of the HVPS (horizontal velocity profile sensor) package. Large lenses and bulky support electronics will minimize its efficacy.
High sensitivity. It may be desirable to look for changes in the ambient levels that happen faster than normal ambient level changes induced by the circadian cycle.
Day/night operation. The use of thermal detectors to detect and classify human targets permits operation during both day and night. Visible detectors are rendered superfluous during inclement weather conditions and during low ambient light levels.

### Optics Theoretical Background

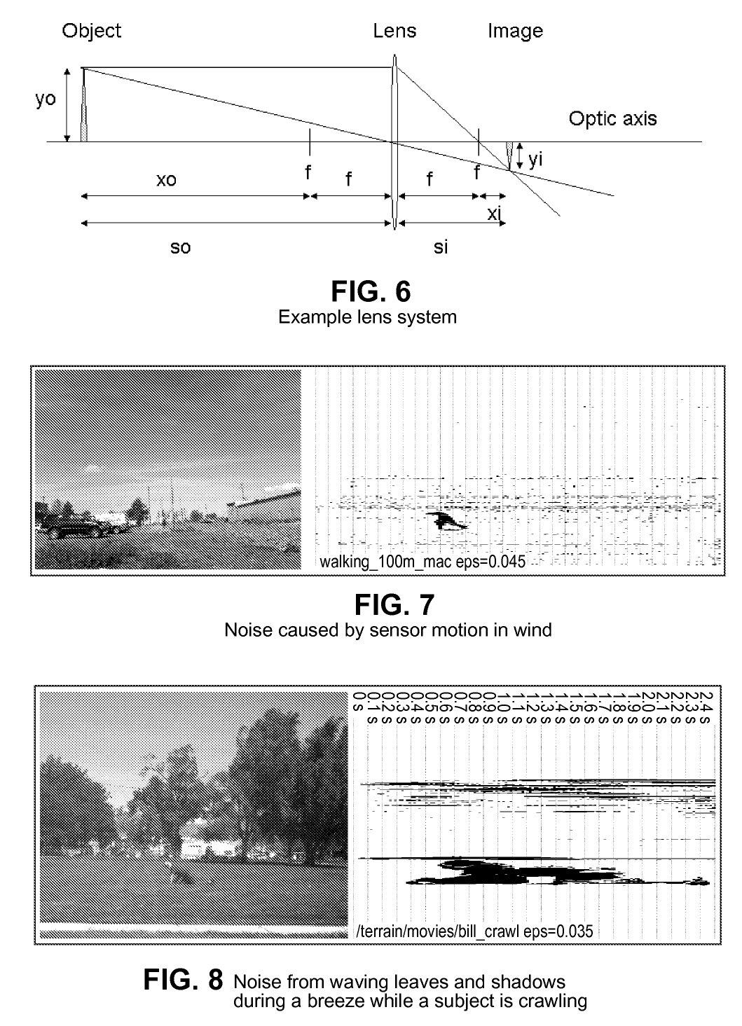

To optimize the detector 106's performance with optics 108, it may be helpful to understand the parameters of a lens. FIG. 6 shows the ray diagram of the image of an object as seen through one convex lens L. Two parameters determine where the image will appear and how large it is: The focal length f of the lens and the distance of the object from the lens sₒ. The focal length defines the point to which a bundle of rays passing through a converging lens parallel to the optic axis converges. The object has a height of yₒ, and the image height is yᵢ.

Both of the lens' focal points are drawn. Which one is applied, depends on which side the object is located and on the type of lens. The distance of the object from the lens sₒ is equal to the sum of xₒ and f; similarly the distance of the image from the lens is the sum of xᵢ and f. By relating the parameters through similar triangles, the following relationships are derived:

$${M}_{T} ≡ \frac{\vert {y}_{i} \vert}{{y}_{o}} = - \frac{{s}_{i}}{{s}_{o}} = - \frac{f}{{x}_{o}} = - \frac{{x}_{i}}{f}$$

$$\frac{1}{f} = \frac{1}{{s}_{i}} + \frac{1}{{s}_{o}}$$

$${f}^{2} = {x}_{o} \cdot {x}_{i}$$

$${M}_{L} = \frac{\partial {x}_{i}}{\partial {x}_{o}} = - \frac{{f}^{2}}{{x}_{o}^{2}} = - {M}_{T}^{2}$$

M_{T} is the transverse magnification factor and M_{L} is the longitudinal magnification factor. After applying these formulas to meet the specifications above, placing a human object, height 2 m, 100 m away from the lens, with a CMOS camera attached we obtain the results listed in Table 1 below. For example, cell phone camera lenses typically have a focal length of around 3.5 mm.

TABLE 1
Calculations of image height and pixels for different
focal lengths and pixel sizes and object sizes.

| Focal | Object | Object | | CMOS | |
|---|---|---|---|---|---|
| length | height | distance | Image ht. | pixel | Image ht. |
| (m) | (m) | (m) | (m) | (μm) | pixels |
| 0.0035 | 2 | 10 | 0.0007 | 2.2 | 318 |
| 0.0035 | 2 | 100 | 0.00007 | 2.2 | 32 |
| 0.0035 | 0.5 | 10 | 0.000175 | 2.2 | 79 |
| 0.0035 | 0.5 | 100 | 0.0000175 | 2.2 | 8 |
| 0.01 | 2 | 10 | 0.002 | 6 | 333 |
| 0.01 | 2 | 100 | 0.0002 | 6 | 33 |
| 0.01 | 0.5 | 10 | 0.005 | 6 | 83 |
| 0.01 | 0.5 | 100 | 0.0005 | 6 | 8 |

Another figure of merit often encountered when selecting a camera is the “f-number” f/# or focal ratio. It is defined as the ratio between the focal length and the diameter of the aperture in front of the lens. For example, f/2 means that the f/2=2 and that the focal length is twice the size of the aperture. A smaller f-number permits more light to reach the image plane. The size of the f-number is inversely proportional to the exposure time will be, ie. a large f-number will shorten the exposure time.

### Ambient Sensing, Noise Sources

The example implementation of device 100 senses high frequency changes in ambient lighting conditions and as such may periodically adjust these values for changes in sun position, which change the shadows, and weather. These phenomena occur relatively slowly (generally >10 seconds in the near field) opposed to the passage of animals and vehicles that in duration are generally less than 10 seconds. The exemplary illustrative non-limiting system may average its ambient levels over time so that the following conditions are met:

1. An average light balance is maintained. The sensor's shutter speed or lens opening can be adjustable by the processor to maintain the proper exposure levels for current conditions.

2. Low frequency radiation changes can be filtered when no targets are present. Reasonable targets should preferably not be filtered from the analysis stream in the exemplary illustrative non-limiting implementation.

3. High frequency noise should be filtered where possible (moving trees for example). One possible solution is to adjust the view frame to exclude scene portions that cannot have targets (the sky, tree tops, flags, roads, etc.) or are likely noise sources.

Typical use of these detector has them positioned perpendicular to likely target paths with an initial setup to establish an ambient baseline. This can be corrected continuously (or at frequent intervals) for the sensor device's lifetime.

1. Sensor motion. The wind (and experimenter) can cause the display to which the camera is mounted to oscillate somewhat resulting in horizontal noise particularly in areas with high frequency color changes and less so in low frequency areas such as a blue sky. FIG. 7 show exemplary illustrative non-limiting resulting images for a subject near the center of the field of view.

2. Wind. Even a low velocity wind (˜5 mph in the following) generates significant noise as shown (see FIG. 8). However, much of this noise resembles the wobble above and appears as horizontal lines of varying thickness. A simple convolution filter (e.g., horizontal Sobel 2×2) can be used to remove these artifacts when developing the target profile in the next step. The steps may include for example but are not limited to:

a. Filter the accumulated image (perhaps on the fly)

b. Locate any potential objects (large blobs)

c. Subtract the filtered image except near the object

d. Reacquire the object

An alternative approach establishes an average and standard deviation for each pixel. The image is generated wherever the distance between the pixel value and the mean exceeds some multiple of the standard deviation.

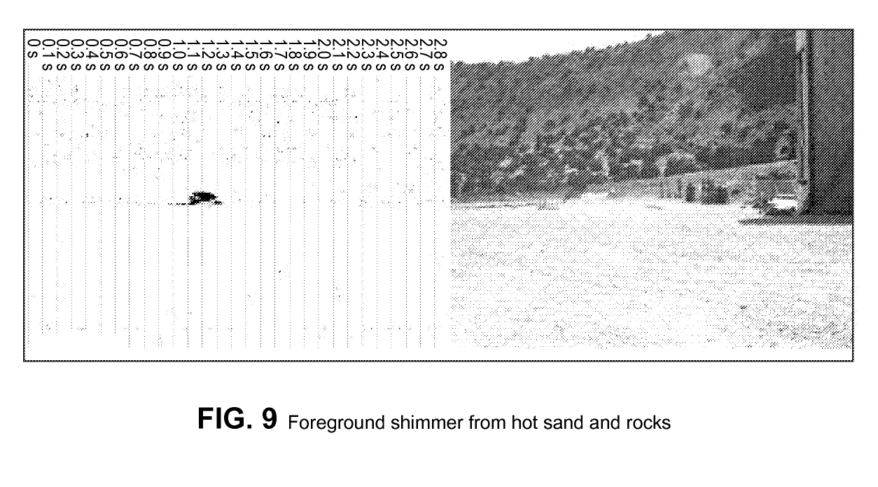

3. Shimmer. This can be a particular problem in hot areas with high contrast ground components causing differential heating. Objects walking across black top highways or near field of view objects can generate random sparkle. The problem is exacerbated by objects saturating the camera's white range as the CMOS sensors become more sensitive with more light. The system can tune itself in the presence of temperature extremes. In FIG. 9, shimmer caused by heating of rocks and gravel in the foreground is present though not in the same quantity as that caused by wind in the trees.

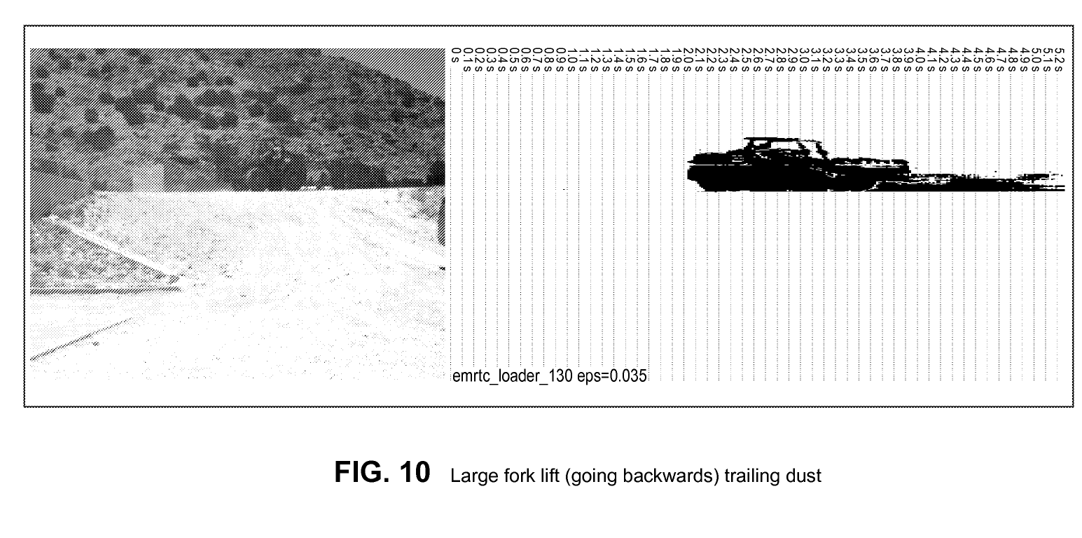

4. Dust. Dust trailing an object easily becomes part of its profile depending upon its contrast with the background. This has proven to be less of a problem with humans as their ability to create dust is more limited than large machines. In FIG. 10, a large fork lift, traveling from left to right at about 10 miles per hour is trailing a significant amount of dust.

5. Detector Noise. This comes in various sorts and, for the most part, can be dealt with by careful electronic design. However, much of this is white noise and is easily removed by setting the contrast change threshold above the noise level.

### Looking for Targets

A potential target is signaled in the exemplary illustrative non-limiting implementation by the following non-limiting criteria:

1. Sufficient neighboring cells that have a value change from ambient energy (visible, infrared)

2. The changes last for a sufficient time

3. The changes do not last for too long a time (signals an approaching object or change in ambient levels).

The target acquisition is complete when these non-limiting criteria are no longer perceived by the detector.

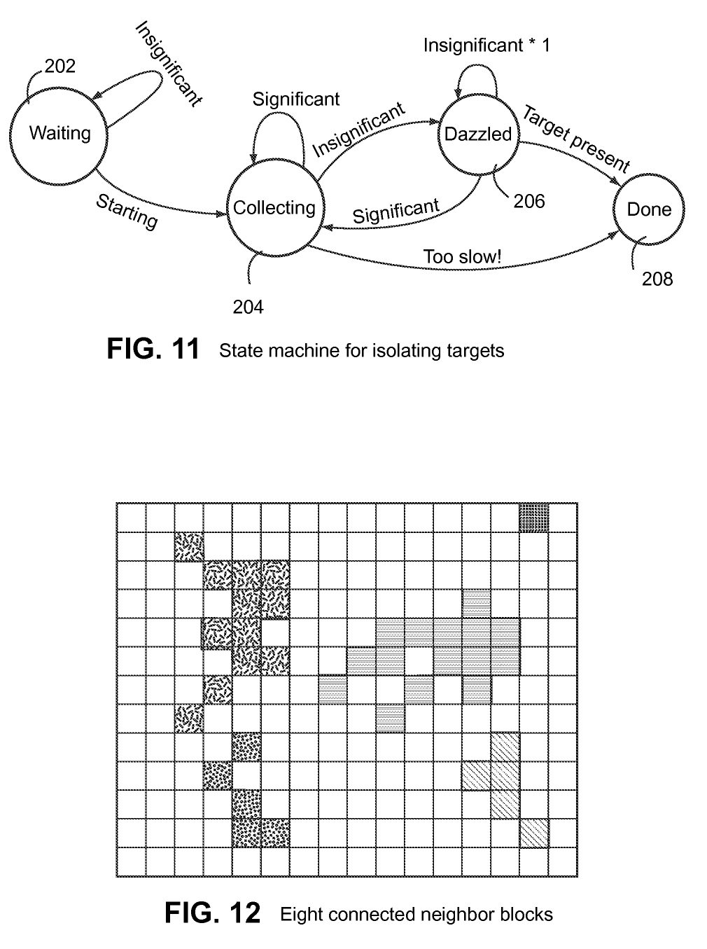

Another non-limiting illustrative implementation of the method in the form of a state machine is shown in FIG. 11. The device lurks in a mode waiting for significant changes (the Waiting state 202). A circular buffer keeps track of all acquired data so that even though the first pixels of a target do not trigger the target collection, they will be there for the next step. When the starting condition is met, the state machine enters a mode of Collecting the data (204). This continues as long as a significant number of pixels meet the target criteria above. If a frame fails to meet the criteria, the object enters the Dazzled state 206—perhaps there is a momentary dropout. Additional frames are captured and if the object criteria are again met we switch back to the Collecting state 204. If the device remains in the Dazzled state 206 for a prolonged period of time, the target acquisition is complete. If too much data is collected, we can now take the time to isolate the object before it leaves the full camera's field of view.

In some of the experiments performed, each object was positioned in the field of view and the entire sequence of data (usually between 50 and 200 frames worth) was processed to isolate the target.

### Building an Object

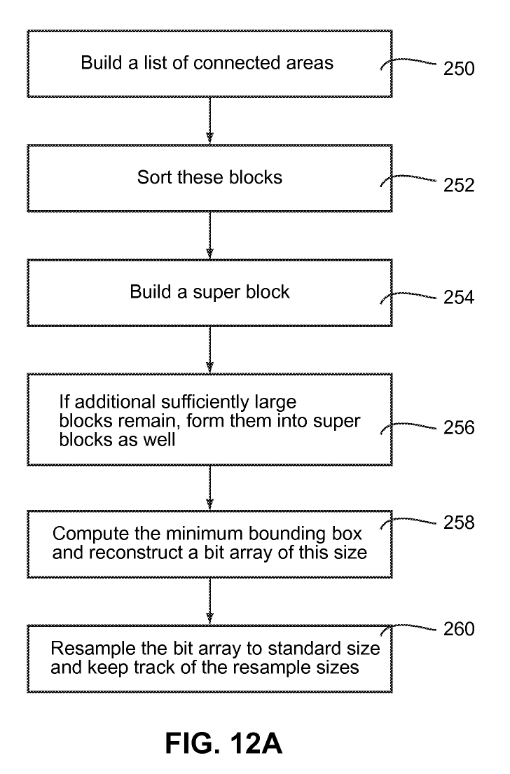

Once the target's time frame has been extracted, the data is also restricted to the target's vertical limits in space, and any spots occurring earlier than the target's time frame that might not have triggered the capture are added back. The following is an illustrative non-limiting example algorithm shown in FIG. 12A.

1. Build a list of all 8 connected areas in the block identified previously (FIG. 12A block 250). For example, FIG. 12 has five 8 connected neighbor blocks each with a distinct color. The algorithm will connect all but the yellow block into a single FIGURE.

2. Sort these blocks into order from largest to smallest (or in some other order) (FIG. 12A block 252).

3. Build a super block by taking the first of these blocks and computing the minimum distance to any remaining blocks (this is an O(n² m²) operation where n is the number of blocks and m the average size of each block). This can be repeated until no more blocks can be added. The naïve algorithm can certainly be improved. (FIG. 12A block 254)

4. If additional sufficiently large blocks remain, form them into super blocks as well (block 256). In this fashion, multiple targets can be acquired from a single sequence and all compared against the library. Insufficiently large blocks are removed from consideration as probable noise. Small areas of change not near enough to a large block are also discarded.

5. Compute the minimum bounding box and reconstruct a bit array of this size (block 258).

6. Resample the bit array to a standard size and keep track of the resample sizes (block 260).

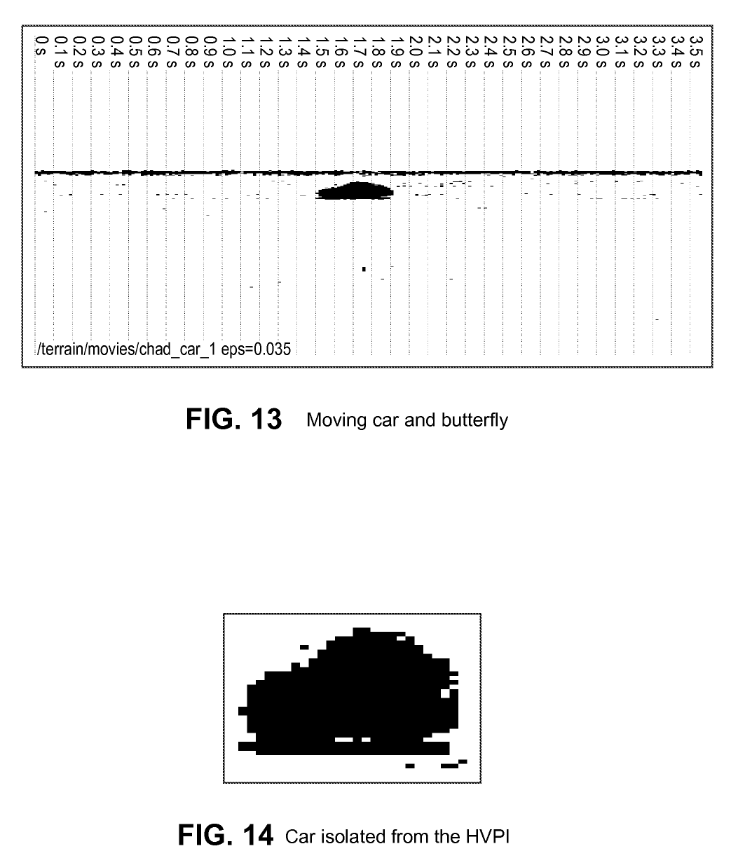

For example, FIG. 13 shows a noisy image (a butterfly flew parallel to the camera's field-of-view) and FIG. 14 a magnified and stretched result of isolation using this method. The process has removed most noise not intimately connected with the moving figure. This mechanism suffers when the noise becomes part of the detected object and is a substantial problem.

Problems with Objects

Any approach separating objects from the environment can have trouble with the following:

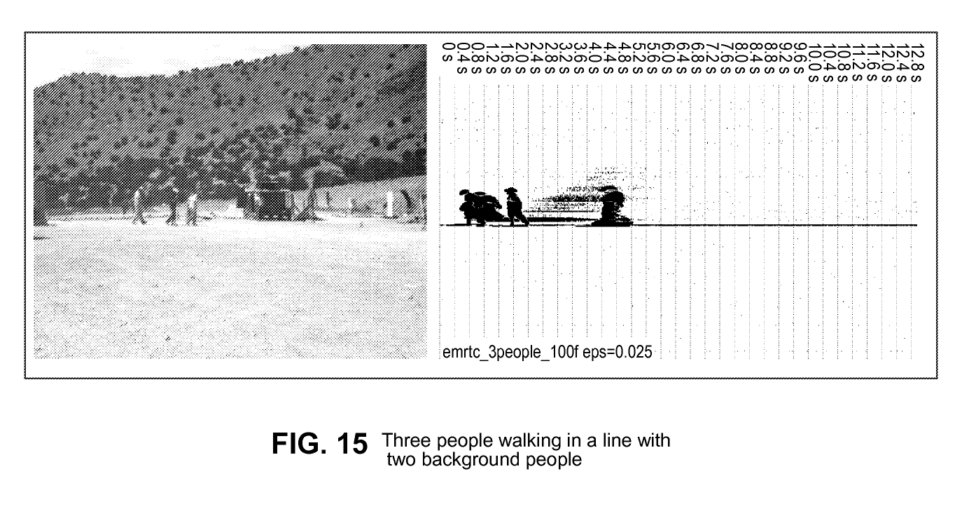

1. Occlusion. One object can be hidden from or be part of an object between it and the object in front. For example, FIG. 15 has three people walking in a line with a fourth person occluded by the first. The object building algorithm may well conglomerate the first three into a single object. A fifth, low contrast person in the background walking towards the camera causes considerable noise that may connect even the fourth person.

2. Noise. Trees, wires, birds, butterflies and other random objects generate noise that may cause objects to be attached to each other though they are separate. FIG. 15 has two people that will be connected by the noise between them.

3. Shadows. At certain sun angles, shadows may connect the objects into a single one particularly if they are moving close together.

### Searching the Catalog

The catalog of known human forms may consume considerable space. However, this catalog will be considerably smaller than might be expected if we match static pictures. Analysis shows that basic human motions involving horizontal movement are stereotypical—only a relatively few HVPI's (horizontal velocity profile images) characterize crawling, walking, and running.

The HVPI catalog can be created in a laboratory setting and images stretched to some basic size related to the target object's typical aspect ratio. For example, humans are (usually) taller than wide, and a two or three to one aspect ratio seems to effectively capture walking at reasonable speeds.

There are two target types in the library: those that cause an alarm and those that don't. The characteristics of good catalog entries include the following:

1. Sufficient detail can be stored to minimize false alarms and rejections.

2. The number of images increases the search time linearly.

3. It is best to include non-alarm targets as well—a positive identification of such reduces the false alarm rate and reduces the reliance on a fixed target match threshold.

4. Targets that do not change their shape with time need only a few images (e.g. a few different kinds of cars, trucks, vans, SUVs, motorcycles, front loaders, etc,).

5. The search time is limited by the alarm target's maximum velocity at the nearest possible position.

### Exemplary Illustrative Non-Limiting Image Comparison

Some exemplary illustrative non-limiting implementations can use among other things a very simple comparison. For a target T size n×m and the functions 0≦X(i,n,m)<32 and 0≦Y(j,n,m)<64, and a catalog entry L_{i,j}, we compute a match 0≦V<1 by:

$$V = \frac{{\sum }_{i = 0}^{i < 32} {\sum }_{j = 0}^{j < 64} \{ \begin{matrix}{L}_{i , j} = {T}_{X ( i , n , m ) , Y ( j , n , m )} \text{:} 1 \\ {L}_{i , j} \neq {T}_{X ( i , n , m ) , Y ( j , n , m )} \text{:} 0\end{matrix} \}}{2048}$$

We can count the number of pixels that are identical and normalize to the image size. While this algorithm appears to have reasonable results, it may also have a number of drawbacks such as:

1. It forces all images into a fixed aspect ratio not justified by the real object's appearance.

2. For slow, large, or far away objects, the X and Y functions tend to remove essential detail. Using an X′ and Y′ inverse functions would increase the search time for large, slow, or far away objects.

It is possible to include some additional characteristics that can be used to improve the search speed. To minimize power consumption and speed processing, these should preferably be relatively simple. Illustrative non-limiting examples include:

1. Aspect ratio. Humans can only walk so slow and run so fast. A low aspect ratio HVPI indicates either a human approaching the sensor or a very large object. Setting an aspect-ratio range gate when comparing two HVPIs may reduce the likelihood of generating a match between a large object and a slow moving human. Humans approaching a sensor will be ignored; if a human target approaches one sensor, an alternative sensor nearby in the network will see the target in profile and report.

2. HVPI (horizontal velocity profile image) Density. Pixels representing a detection or a change are ON and pixels that do not represent a detection or a change may be considered OFF. Assuming the horizontal velocity profile image is normalized to the size of the library image, the ratio of HVPI pixels ON to pixels OFF may be a simple initial matching mechanism that reduces search time.

### Exemplary Illustrative Non-Limiting Catalog Contents

The image catalog can be generated from videos taken in a laboratory or other setting. We can use high quality video capture of subjects in a high contrast setting. There will be minimal background noise and subjects will be selected from those most common:

1. Humans walking, running, and crawling. Depending upon the target audience, they may also be carrying backpacks or weapons. Obese targets may also be recorded if identification of their movements is sufficiently different from that of average-sized human profiles.

2. Quadrupeds walking and running. Likely subjects include dogs and horses as they are sufficiently trainable to walk in front of the recording device. We believe that horses are sufficiently similar to cows and deer as to provide positive identification.

3. Machinery. We can record cars, trucks, vans, SUV's, bicycles, motorcycles, and other common equipment. Though there are many such devices, they rarely exhibit geometric changes during passage (bicycles being the exception) and therefore require a minimal number of images in the catalog. Positive identification of these objects generally implies human presence.

The library of velocity profiles can be relatively small yet a wide variety of moving targets can be correctly classified. Several approaches are possible:

1. Store only human profiles. We compare a captured velocity profile against all of these and if a threshold is reached the target is human.

2. Store most likely profiles. If we also include cars, trucks, and various quadrupeds these will more likely be matched and the threshold for identification can be lowered.

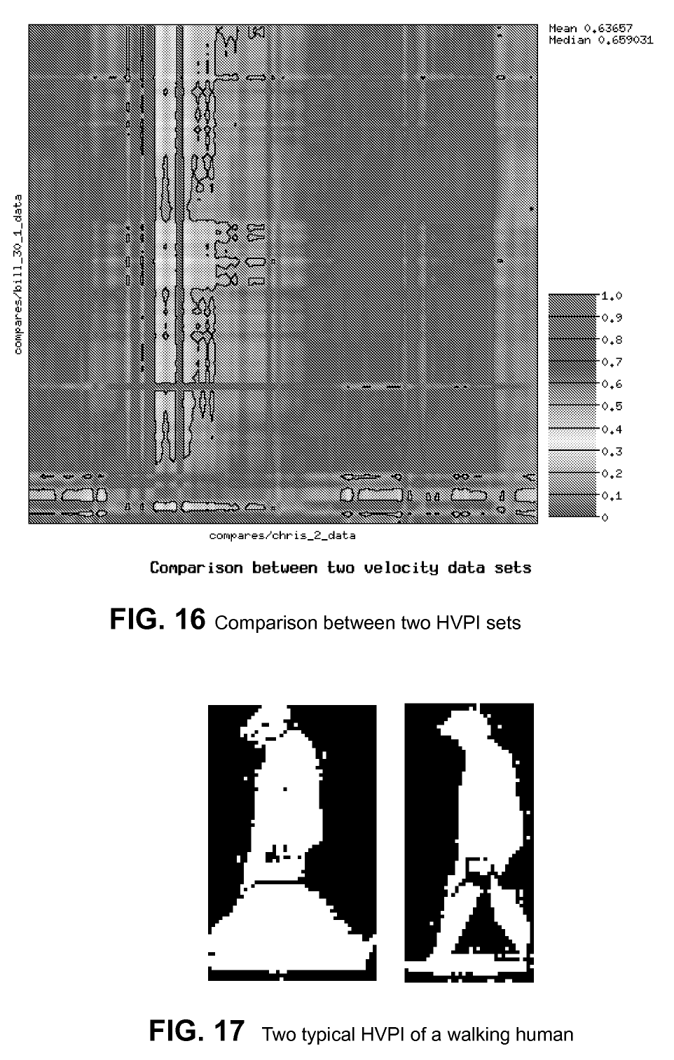

To help understand this problem, we compared two subjects by their foot phases during a walking sample. In FIG. 16, the horizontal axis represents a HVPI's taken from a single video sequence with the column moved one pixel at a time across two complete footsteps. The vertical axis is the same but from a different subject. The saturation represents the comparison between the frames of both subjects—green has a very low correlation value ranging to yellow, orange, red, and magenta with the highest correlation. As you can see from the median and mean values, the average correlation is high.

These results indicate that there are two or perhaps three characteristic HVPI poses characteristic of human walking. Examining movies constructed from multiple HVPI's confirms this. FIG. 17 shows two typical HVPIs of a walking human. The first occurs when one foot is on the ground in the frame and the second is when neither foot is on the ground.

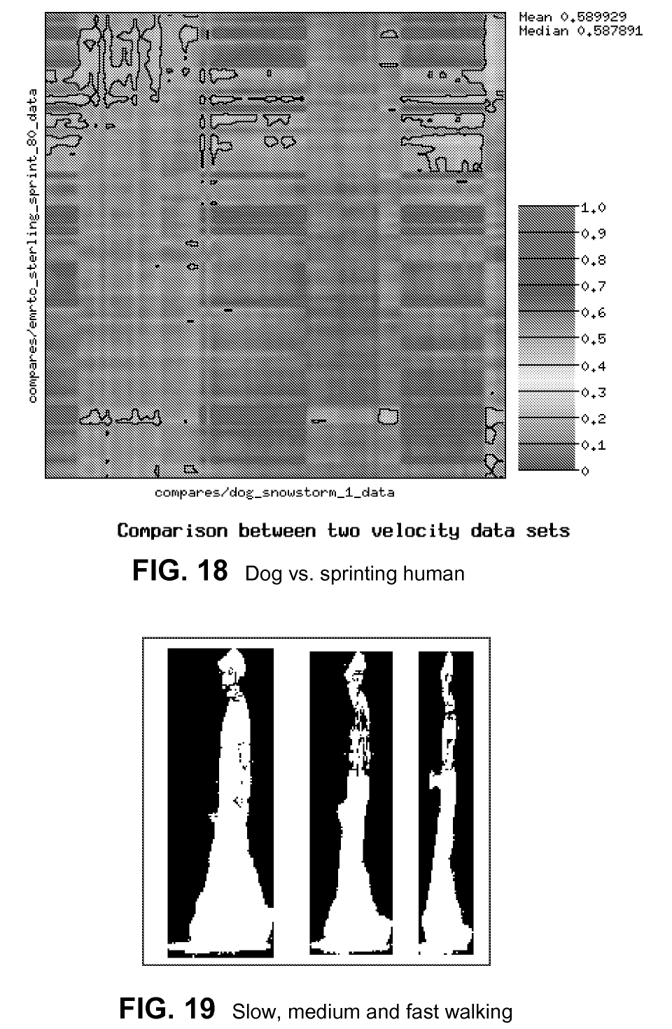

When we run the same comparison between a dog and a human, the numbers are much lower than comparison between humans. Very few frames match sufficiently to trigger a match—this graph does not indicate that a better match could be found against a human (FIG. 18).

Experiments can be run to determine how many images should preferably be stored for positive human identification.

### Velocity and Distance Estimates

Most humans are about 5′10″ tall and are traveling at between 3.5 km/h (slow walk) and 8 km/h (fast walk), 1 km/h crawling, and 15 km/h running. This allows us to estimate distance and velocity from the target's size. When we locate a target, we resample it to the standard catalog size and retain the scale factor required to do so.

Consider the following example (FIG. 19) where we use the horizontal scale factor to determine velocity. A subject walked by the camera at 10 meters at 0.99 meters/second, 1.36 ms/s, and 2.18 m/s (determined by analysis of the original video). These ratios are 1, 0.73 and 0.45 using the slowest as the base. The size ratios from selected HVPI are 1, 0.78, and 0.5 generating velocities of 0.99 m/s, 1.27 m/s and 1.94 m/s respectively an average error of around 10%. With the vagaries of noise, distance, and pattern matching, we can expect this average error to increase.

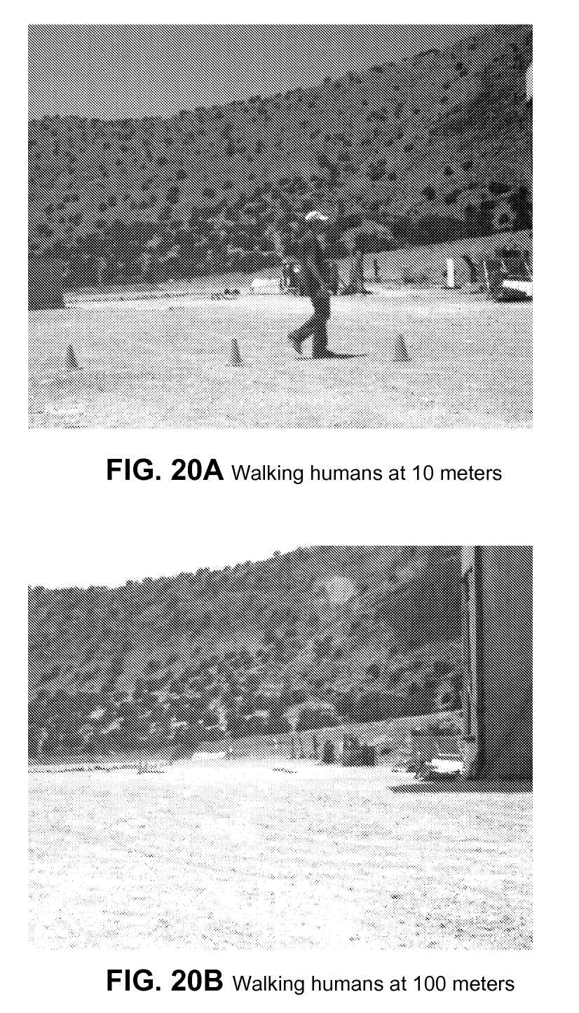

Distance can be calculated in a similar fashion. Assuming that all targeted humans are about 1.8 meters tall and knowing the distance used to create the catalog human allows a simple, if inaccurate, calculation for distance. For example, two samples of different experimenters (about the same height) walking, were taken at 10 and 100 meters respectively (FIG. 20A, 20B).

The average height (in pixels) of the subject 10 meters from the camera is 192 pixels (at fast walking speeds, this reduces to about 184 pixels). The subject 100 meters away from the camera averages about 21 pixels. Assuming that the image sensor is about 5 mm tall, and simple projections, we compute the distance as about 91 meters an error of approximately 10%.

### System Accuracy

We recorded various subjects with video cameras that could record digital images. These included the Photron high-speed, black and white, or color video cameras and the webcam on a Macintosh laptop. Targets ranged from 30′ to 130′ distant and included walking and running individuals, dogs, bicycle riders, and cars. Backgrounds included an off-white painted warehouse, a suburban street, and a city park. Specifically:

| | Camera: | | |
|---|---|---|---|
| | | Photron Fastcam-X | |
| | Photron | 1280-PCI | Apple Webcam |
| Lens: | 50 mm, F1.4 | 12.5 mm F1.4 | ? |
| Sample rate: | 60 Hz | 60 Hz | 30 Hz |
| Shutter speed: | 1/5000 second | 1/250 second | ? |
| Mode | Black & White | 8 × 8 × 8 color | Color |
| Sample size: | 512 × 512 | 640 × 512 | 640 × 480 |

The targets generally moved perpendicular to the camera while a number of frames were collected and stored. These frames were converted to a 128 level grey scale Microsoft BMP files for analysis. The color maps varied somewhat from frame to frame and can be normalized by the exemplary non-limiting analysis program. This proceeded as follows:

1. Select one column.

2. Compute the column's mean and standard deviation grey value (0→1) for the first few frames to establish a background ambient value.

3. For all subsequent frames, compute a bit vector with a 1 where the corresponding value differs by more than some multiple of the standard deviation of the background values.

4. Display the bit vectors in two dimensions.

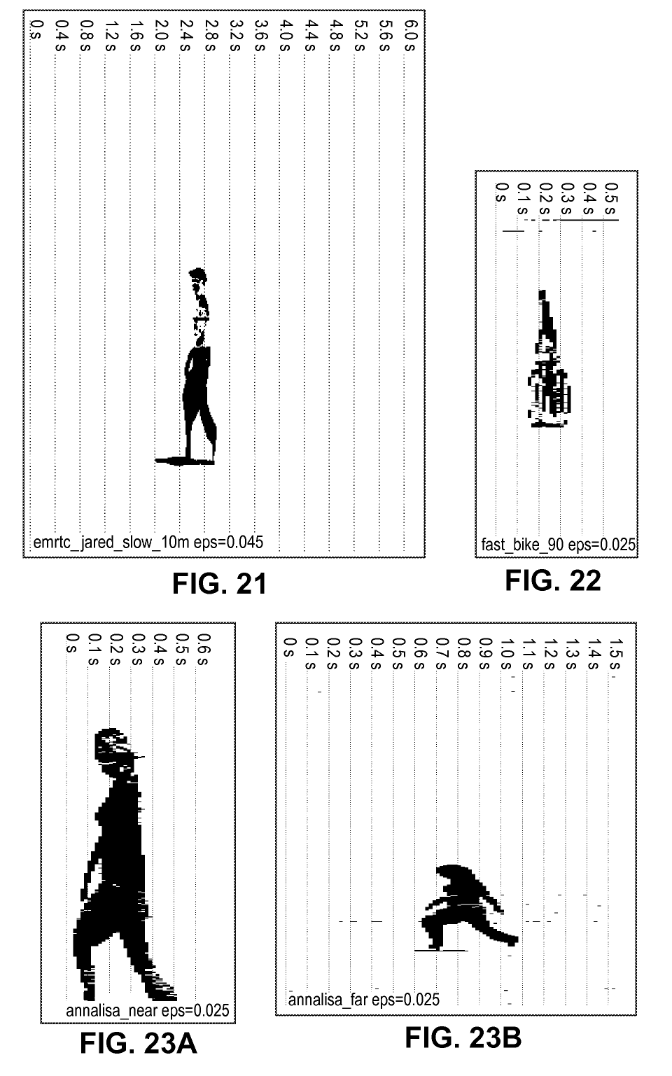

For example, one frame of a slow walker is shown in FIG. 21 with its corresponding bit display. There is some loss of data in the subject's shirt area because there is a lack of contrast with the background. Remember that the bit vector display is repeated samples taken at the red line and not derived from the single image shown (a total of 397 frames were taken).

When the bicyclist speeds up, the picture is compressed along the horizontal axis. At the same location, going about twice as fast, the result in FIG. 22 is more difficult to identify. However, we can use this fact to compute how fast the object is traveling: expand the bit image to match a slow moving master image and use the expansion to calculate the speed.

Similarly, we can approximate the distance by size similar to the way our eyes perform. In FIG. 23A, we see a target at 30′; in FIG. 23B, we see a target at 130′ (the 30′ one is missing the target's lower 1 foot). The approximate size ratio is 1 to 4, the distance can be computed to about 75% accuracy given approximate heights of human targets (the subject is near 6′).

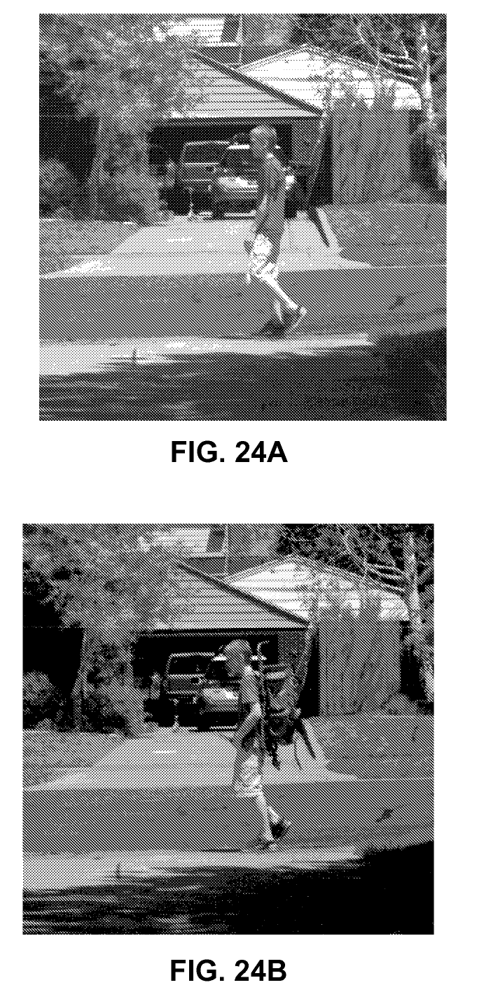

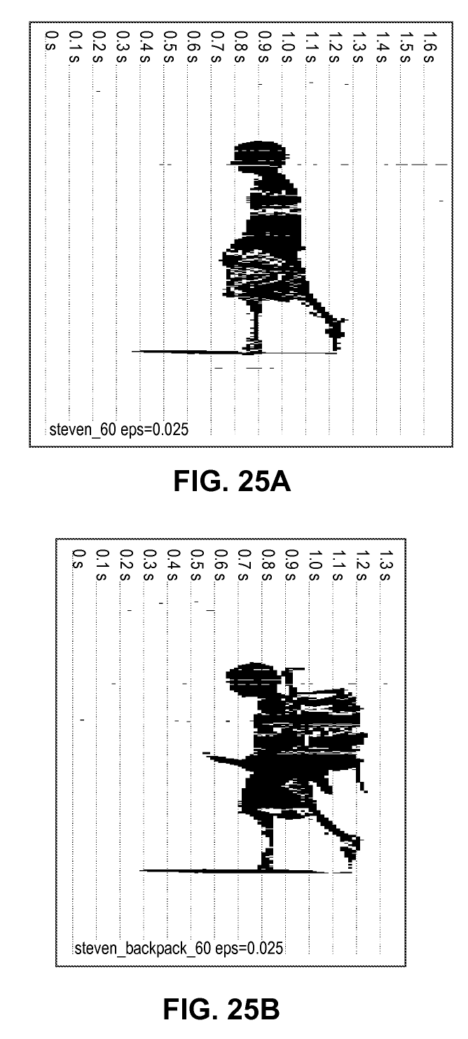

We are also able to tell some gross physical characteristics such as whether or not the subject is wearing a back pack (FIG. 24A, 24B). The following 5′2″ individual walked both with and without a back pack (FIG. 25A, 25B). The distance to the subject is 60′ and the subject did not swing his arms in a normal fashion.

While the technology herein has been described in connection with exemplary illustrative non-limiting implementations, the invention is not to be limited by the disclosure. For example, while the exemplary illustrative implementation may be applied to many different moving target types, it has been useful to consider the human as an example moving target. Conversely, the exemplary device described herein classifies a human target by a velocity profile as measured by the detector, a linear sensor array or one column or row of a two-dimensional sensor array but other sensors are also possible. The device may also be referred to as the Horizontal Velocity Profile Sensor (“HVPS”) and the analysis it performs as “Horizontal Velocity Profiling” (“HVP”). Thus, the invention(s) is/are intended to be defined by the claims and to cover all corresponding and equivalent arrangements whether or not specifically disclosed herein.

We claim:

1. A method of identifying and classifying objects comprising:
sensing a field of view to detect change in background; in response to detected change in background, increasing sensing sample frequency and recording images until no change in background is detected;
recognizing human objects in response to said sensing, at least in part by processing and comparing horizontal velocity components that are substantially uniform across most human movements; and
outputting an indication of at least one recognized human target.

2. The method of claim 1 further including comparing at least one image of a moving target to a stored target library.

3. The method of claim 1 further including autonomously classifying moving targets.

4. The method of claim 1 further including autonomously recording a moving target image.

5. The method of claim 1 further including autonomously recording time of detection.

6. The method of claim 1 further including recording moving target horizontal velocity.

7. The method of claim 1 further including recording moving target direction.

8. The method of claim 1 further including counting moving target by type.

9. The method of claim 1 further including recording the type and corresponding number of moving targets.

10. The method of claim 1 further including storing a library of target types.

11. The method of claim 1 further including transmitting target recognition information to a remote location.

12. The method of claim 1 wherein said sensing includes detecting electromagnetic energy in the visible range, the near infrared, the mid-infrared and/or the long-wave infrared.

13. The method of claim 1 further including upgrading target type information.

14. The method of claim 1 further including tailoring said recognition to accommodate different types of applications from long-range to short-range surveillance.

15. Apparatus for detecting moving human targets comprising:
a sensor that senses electromagnetic radiation;
at least one storage arrangement that stores a library of target information; and
a controller connected to said sensor and said storage arrangement, said controller controlling said sensor to sample a field of view at a low frequency during a moving target detection mode, for controlling said sensor to increase sample frequency upon detection of a moving target, and comparing captured horizontal velocity information with stored target information to autonomously classify detected targets.

16. Apparatus as in claim 15 wherein said sensor comprises a camera.

17. Apparatus as in claim 15 further including an optical lens associated with said sensor, said optical lens providing the following relationships
$${M}_{T} ≡ \frac{\vert {y}_{i} \vert}{{y}_{o}} = - \frac{{s}_{i}}{{s}_{o}} = - \frac{f}{{x}_{o}} = - \frac{{x}_{i}}{f}$$
$$\frac{1}{f} = \frac{1}{{s}_{i}} + \frac{1}{{s}_{o}}$$
$${f}^{2} = {x}_{o} \cdot {x}_{i}$$
$${M}_{L} = \frac{\partial {x}_{i}}{\partial {x}_{o}} = - \frac{{f}^{2}}{{x}_{o}^{2}} = - {M}_{T}^{2} .$$

18. Apparatus as in claim 15 wherein said controller filters noise caused by natural motion phenomena including wind.

19. Apparatus as in claim 15 wherein said controller takes into account shimmer.

20. Apparatus as in claim 15 wherein said controller takes into account dust clouds.

21. Apparatus as in claim 15 wherein said controller operates in a dazzled state to capture additional images during temporary dropouts.

22. Apparatus as in claim 15 wherein said storage arrangement stores a compact representation of object signatures based on observation of consistent movement velocity for human movements.
